(19) United States
(12) Patent Application Publication
(10) Pub. No.: US 2005/0158154 A1
(43) Pub. Date: Jul. 21, 2005

(54) Warehouse system and a method for temporary storage of articles

(76) Inventors: Petrus Adrianus Lambertus Leerintveld, Rossum (NL); Ronald Jan Mantel, Enschede (NL)

Correspondence Address: Richard L Byrne, 700 Koppers Building, 436 Seventh Avenue, Pittsburgh, PA, 15219-1818, US

(21) Appl. No.: 10/484,675

(22) PCT Filed: Jul. 19, 2002
(86) PCT No.: PCT/NL02/00485

(30) Foreign Application Priority Data
Jul. 25, 2001 (NL) 1018629

(51) Int. Cl. B65G 1/00

(52) U.S. Cl. 414/277

(57) ABSTRACT

A warehouse system comprising several storage racks each comprising a number of compartments arranged above each other and beside each other, and a unit which is movable along said compartments and which comprises a mechanism which is capable of moving a container from the unit into a compartment and from a compartment onto the unit. The unit can be moved over the storage racks from a space located between two storage racks to another space located between two storage racks. A conveyor is provided, which conveyor is positioned beside the unit in the uppermost position of said unit and which can be moved over the storage racks together with the unit.

The invention relates to a warehouse system comprising several storage racks each comprising a number of compartments arranged above each other and beside each other, and a unit which is movable along said compartments and which comprises a mechanism which is capable of moving a container from the unit into a compartment and from a compartment onto the unit, which unit can be moved over the storage racks from a space located between two storage racks to another space located between two storage racks, wherein a conveyor is provided, which conveyor is positioned beside the unit in the uppermost position of said unit and which can be moved over the storage racks together with the unit. The conveyor may be a belt conveyor, for example, or a conveyor consisting of driven rollers.

Such a warehouse system is known from U.S. Pat. No. 4,014,442. The unit is within relatively close range of the conveyor at all times, and the unit is positioned beside the conveyor when the unit is being moved over the storage racks, so that containers can be exchanged between the conveyor and the unit during said movement. U.S. Pat. No. 4,838,749, shows a warehouse system in which the unit is suspended by means of cables from a frame which can be moved over the storage racks.

When the frame is present at a space located between two storage racks, the unit can be moved down in said space for removing containers from compartments or placing containers into the compartments. Several containers can be moved simultaneously from containers arranged beside each other. A conveyor is present in one or more storage racks for supplying and discharging the containers, so that the unit can move to specified places for delivering containers to the conveyor or receiving containers from the conveyor.

Such a warehouse system may be used for the temporary storage of articles which subsequently leave the warehouse in the form of shipments whose composition may vary with each new shipment. Every compartment of the warehouse can accommodate a container which has been placed therein by the mechanism that is present on the movable unit. A container can accommodate several containers arranged one behind another, for example, in which situation the mechanism is capable of removing the desired container from the compartment.

A container will contain a number of identical articles, for example, and the movable unit will remove a number of containers from the compartments so as to compose a shipment. Said containers are subsequently taken to an order compiling location, wherein an order compiler removes articles from the various containers and places them into a shipment box. Containers which are not needed by the order compiler (any more) are returned to the compartments by the unit. Each individual container can be placed in a random compartment, whilst a control unit registers what container is present at what location. Containers which are frequently needed by the order compiler can be placed in a compartment which is located “closer” to the order compiling location.

Especially in the case of a warehouse for articles which only need to be stored for a short period of time, speed and flexibility are essential when compiling orders. In addition, a compact construction of the racks in the warehouses important, also in order to reduce the amount of time required for the various movements.

The object of the invention is to provide an efficient warehouse system which enables a quick and effective compilation of orders having a complex composition.

According to the invention, conveying means extending along the storage racks at the level of the conveyor are present, to which conveying means the conveyor can deliver containers or from which the conveyor can receive containers. Hereby the the containers to be stored in the warehouse system can be supplied to, and discharged from, the conveyor in a very efficient manner.

Preferably, the unit is vertically movable in a frame, which frame can be moved in horizontal direction, and the conveyor is likewise arranged in said frame. The frame can be moved with respect to the storage racks together with the unit and the conveyor in that case, so that the unit can move downwards in various spaces between the storage racks so as to reach the compartments in the storage racks.

In one preferred embodiment, the frame comprises one element which extends above the storage racks and two downwardly extending elements on either side of the racks, which elements guide the unit during its vertical movement in the space between the racks. The downwardly extending elements of the frame can also form the frame supports, for example in the situation in which the frame traverses the floor on which the storage racks are present on wheels. This will be explained in more detail by means of an embodiment.

In one preferred embodiment, two conveyors are present, which conveyors are positioned on either side of the unit in the uppermost position of said unit. In that situation, containers can be supplied to the unit via one conveyor after the unit has delivered containers to be discharged to the other conveyor.

The invention furthermore relates to a frame which is movable with respect to warehouse racks which each comprise a number of compartments arranged above and beside each other, which frame comprises a unit which is movable with respect to the frame, said unit comprising a mechanism which is capable of moving a container from the unit into a compartment and from a compartment onto the unit, wherein the frame comprises a conveyor onto which the unit can place containers in the uppermost position of the unit, and wherein the conveyor is arranged to deliver containers to conveying means extending along the storage racks at the level of the conveyor.

The invention furthermore relates to a method for temporary storage of articles, in which containers with the articles present therein are placed in a number of warehouse rack compartments arranged above and beside each other, in which a mechanism, which is present on a unit which is movable along said compartments, places a container from a compartment onto the unit, whereupon the unit is moved to its uppermost position, in which position the container is placed onto a conveyor, after which the conveyor and the unit are moved in substantially horizontal direction over the storage rack to another warehouse rack, and wherein the container is delivered by the conveyor to conveying means extending along the racks at the level of the conveyor.

The invention will now be explained in more detail by means of an embodiment of a warehouse system, in which reference is made to the drawing.

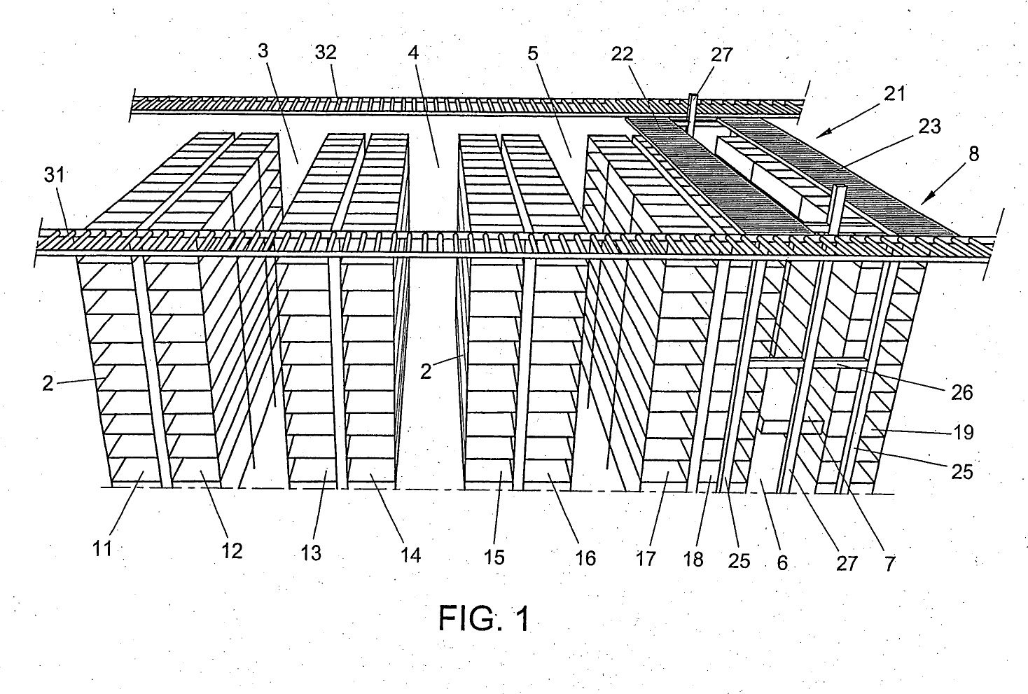

FIG. 1 is a perspective view of a warehouse system;

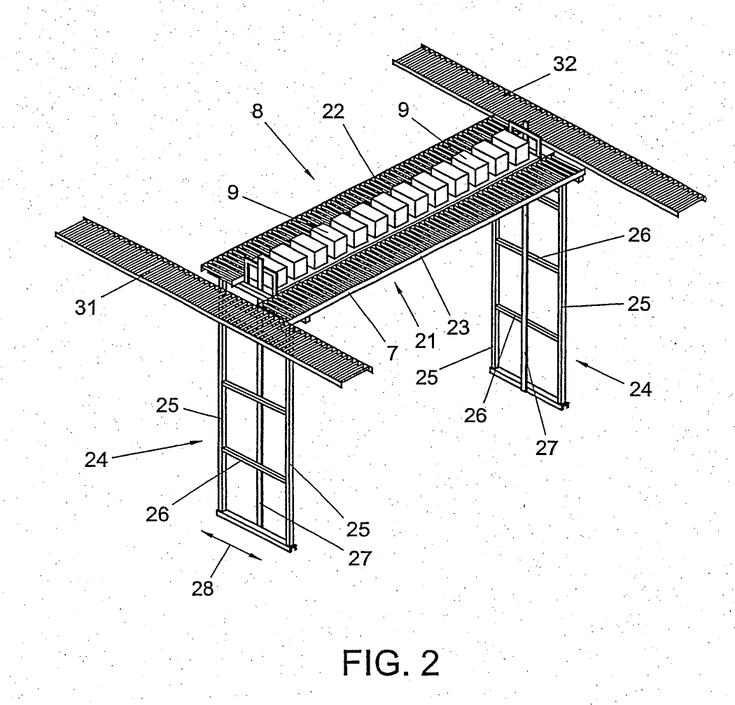

FIG. 2 shows a frame comprising conveying means; and

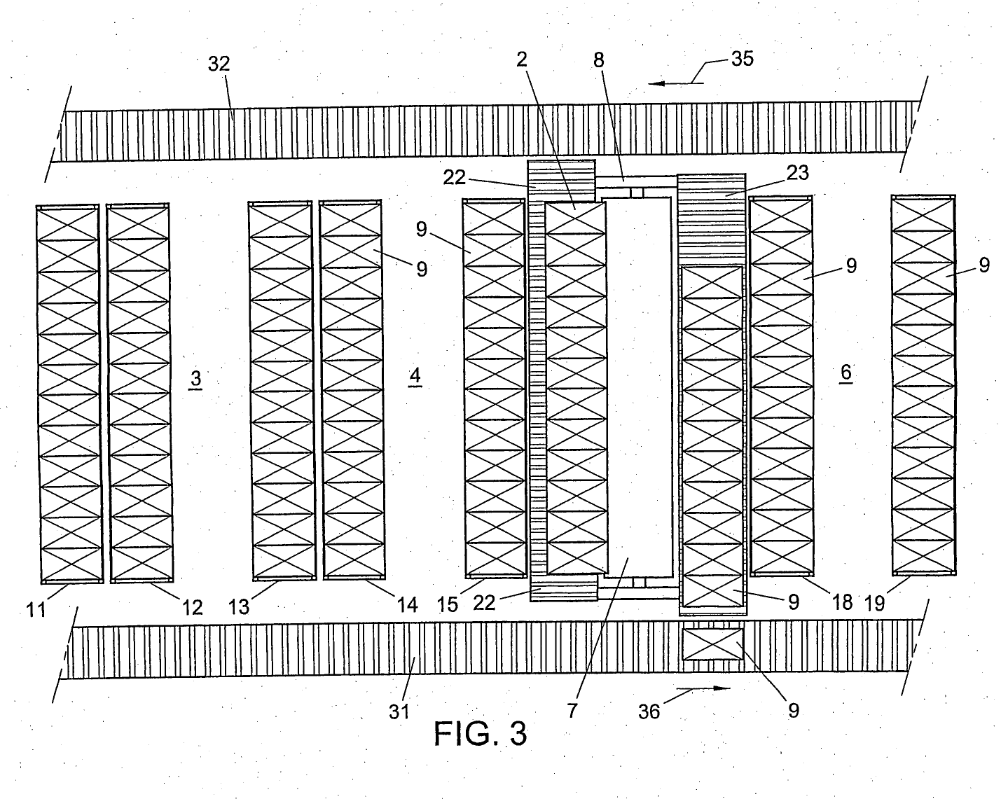

FIG. 3 shows the warehouse system of FIG. 1 in top plan view.

The figures are merely diagrammatic representations of an embodiment, in which the components are shown in simplified form and from which less relevant parts have been left out for the sake of clarity.

FIG. 1 shows nine storage racks 11-19 comprising compartments 2, that is, places where containers may be present, which compartments are arranged above and beside each other. Each storage rack 11-19 comprises 132 compartments, arranged in 12 horizontal rows of 11 compartments arranged one above another. The storage racks 11-18 are arranged in pairs, with their rear sides abutting against each other, so that spaces 3, 4, 5, 6 are present between the storage racks. From said spaces 3-6, the compartments 2 of the storage racks 12-19 can be reached for placing containers 9 (not shown in FIG. 1) into the compartments 2 or removing containers from the compartments 2.

The containers 9 are placed into the compartments 2, or removed from the compartments 2, by a unit 7 which is movable in vertical direction in the spaces 3-6, its movement being guided in a frame 8. The unit 7 is fitted with mechanisms which are known per se for moving containers 9 into or out of compartments 2 when the unit 7 is present at the level of said compartments 2. The mechanisms, which are not shown in the figures, can move several containers 9 into or out of compartments 2 at the same time, and that on either side of the spaces 3-6.

The frame 8, which is shown in perspective view in FIG. 2, has an element 21 extending above the storage racks 11-19 which comprises two conveyors 22, 23, on which containers 9 can be transported by means of driven rollers forming the conveyors 22, 23. In the uppermost position of the unit 7 as shown in FIG. 2, said mechanisms can move containers 9 from the unit 7 onto the conveyor 23 or from the conveyor 22 onto the unit.

The frame 8 furthermore has two downwardly extending elements 24, via which the frame 8 can traverse the floor on wheels (not shown). Each element 24 consists of two vertical beams 25, which are interconnected by cross beams 26. Fixed to the cross beams 26 is a guide beam 27 on which the unit 7 is mounted, which guide beam guides the unit 7 during the vertical movement thereof.

In the uppermost position of the unit 7 as shown in FIG. 2, the frame 8 can be moved in the direction indicated by the arrow 28. This enables the unit 7 to move downwards in each space 3-6 when the frame is positioned at the space in question (space 6 in FIG. 1).

Furthermore, conveying means are present in the form of two conveyors 31, 32 comprising driven rollers, which can supply and discharge containers 9. The conveyors 31, 32 are positioned at the level of the conveyors 22, 23. As is shown in FIG. 2, the conveyor 22 connects to the conveyor 32, and the conveyor 23 connects to the conveyor 31.

FIG. 3 is a top plan view of the warehouse system according to FIG. 1, in which the unit 7 is positioned above the space 5. FIG. 3 shows the containers 9 that are present in the uppermost compartments 2 of the racks 11,12,13,14,15,19.

The figure furthermore shows a row of containers 9 being moved from the conveyor 22 onto the unit 7, as well as a number of containers present on the conveyor 23, which are being moved to the conveyor 31.

The conveyor 32 supplies containers 9 to be stored in the warehouse system in the direction that is indicated by the arrow 35. The containers 9 being supplied are guided from the conveyor 32 onto the conveyor 22, after which they are received on the unit 7, as is shown in FIG. 3. Following that, the containers 9 can be placed into compartments 2 of the storage racks by the unit 7.

Containers 9 to be discharged from the warehouse system are removed from the compartments 2 in question and placed onto the conveyor 23 by the unit 7, after which they are placed one by one onto the conveyor 31 so as to be discharged in the direction indicated by the arrow 36, as is shown in FIG. 3.

As already said before, only those elements that are relevant in connection with the explanation of the invention are shown in the figures for the sake of clarity. Thus, the various control means, for example for steering the containers 9 over the various conveyors 22, 23, 31, 32, are not shown. Such control means are known per se in various embodiments thereof, however. Said control means arrange the transfer of the containers 9 from the conveyors 23 and 32 to the conveyors 31 and 22, respectively, also while the conveyors are moving over the storage racks.

1-9. (canceled)

10. A warehouse system comprising several storage racks each comprising a number of compartments arranged above each other and beside each other, and a unit which is movable along said compartments and which comprises a mechanism which is capable of moving a container from the unit into a compartment and from a compartment onto the unit, which unit can be moved over the storage racks from a space located between two storage racks to another space located between two storage racks, a conveyor positioned beside the unit in the uppermost position of said unit and which can be moved over the storage racks together with the unit, and conveying means extending along the storage racks at the level of the conveyor, to which conveying means the conveyor can deliver containers.

11. The warehouse system according to claim 10, wherein the unit is vertically movable in a frame which can be moved in horizontal direction, wherein the conveyor is likewise arranged in said frame.

12. The warehouse system according to claim 11, wherein the frame comprises one element which extends above the storage racks and two downwardly extending elements on either side of the racks, which elements guide the unit during its vertical movement in the space between the racks.

13. The warehouse system according to claim 10, wherein two conveyors are present, which conveyors are positioned on either side of the unit in the uppermost position of said unit.

14. The warehouse system according to claim 11, wherein two conveyors are present, which conveyors are positioned on either side of the unit in the uppermost position of said unit.

15. The warehouse system according to claim 12, wherein two conveyors are present, which conveyors are positioned on either side of the unit in the uppermost position of said unit.

16. A frame which is movable with respect to warehouse racks, wherein each rack comprises a number of compartments arranged above and beside each other, which frame comprises a unit which is movable with respect to the frame, said unit comprising a mechanism which is capable of moving a container from the unit into a compartment and from a compartment onto the unit, wherein the frame comprises a conveyor onto which the unit can place containers in the uppermost position of the unit, and wherein the conveyor is arranged to deliver containers to conveying means extending along the storage racks at the level of the conveyor.

17. The frame according to claim 16, wherein two conveyors are present, which conveyors are positioned on either side of the unit in the uppermost position of said unit.

18. A method for temporary storage of articles, in which containers with the articles present therein are placed in a number of warehouse rack compartments arranged above and beside each other, in which a mechanism, which is present on a unit which is movable along said compartments, places a container from a compartment onto the unit, whereupon the unit is moved to its uppermost position, in which position the container is placed onto a conveyor, after which the conveyor and the unit are moved in substantially horizontal direction over the storage rack to another warehouse rack, wherein the container is delivered by the conveyor to conveying means extending along the racks at the level of the conveyor.
